(19) United States
(12) Patent Application Publication
(10) Pub. No.: US 2015/0368043 A1
(43) Pub. Date: Dec. 24, 2015

(54) METHOD AND APPARATUS FOR FEEDING IN WASTE MATERIAL FROM AN INLET CHUTE

(71) Applicant: MariCap Oy, Vantaa (FI)

(72) Inventor: Göran SUNDHOLM, Tuusula (FI)

(73) Assignee: MariCap Oy, Vantaa (FI)

(21) Appl. No.: 14/763,366

(22) PCT Filed: Jan. 15, 2014
(86) PCT No.: PCT/FI2014/050025

§ 371 Date: Jul. 24, 2015

(30) Foreign Application Priority Data
Jan. 25, 2013 (FI) 20135075

(51) Int. Cl. B65F 5/00; B65F 1/00; B65F 1/10; E04F 17/12

(52) U.S. Cl. CPC B65F 5/005; E04F 17/12; B65F 1/0093; B65F 1/105

(57) ABSTRACT

Method for feeding in waste material from an inlet chute into the container space of a material container, in which inlet chute is arranged at least one input point, in which is an input aperture for feeding in material into the inlet chute and onwards along a channel section of the inlet chute into a material container, which inlet chute includes a mainly vertical channel section and a section deviating from the vertical direction. The conveying of material to be conveyed in the inlet chute is enhanced at least in the section of the inlet chute deviating from the vertical direction by bringing about a transporting air flow in the inlet chute in the input direction of material towards the material container, which transporting air flow is brought about at least partly with a fan, the blowing side of which fan is connected into medium connection with the inlet chute and/or the suction side of the fan is connected into medium connection with the container space of the material container. The invention also relates to an apparatus.

### BACKGROUND OF THE INVENTION

The object of the invention is a method as defined in the preamble of claim 1.

The object of the invention is also an apparatus according to claim 6.

The invention relates generally to material conveying systems, such as to pneumatic partial-vacuum transporting systems, more particularly to the collection and conveying of wastes, such as to the conveying of household wastes. Such systems are presented in publications WO 2009/080880, WO 2009/080881, WO 2009/080882, WO 2009/080883, WO 2009/080884, WO 2009/080885, WO 2009/080886, WO 2009/080887 and WO 2009/080888, among others. The invention also relates to waste feeding means, such as to input points or refuse chutes, with which waste is conveyed, typically by gravity, e.g. from higher input apertures in residential buildings to a lower collection space or corresponding container.

Systems wherein wastes are conveyed in piping by means of a pressure difference or suction are known in the art. In these, wastes are conveyed long distances in the piping by sucking. It is typical to these systems that a partial-vacuum apparatus is used to achieve a pressure difference, in which apparatus negative pressure is brought about in the conveying pipe with partial-vacuum generators, such as with vacuum pumps or with an ejector apparatus. A conveying pipe typically comprises at least one valve means, by opening and closing which the replacement air coming into the conveying pipe is regulated. Waste input points, e.g. rubbish containers or refuse chutes, are used in the systems at the waste material input end, into which waste input points material, such as waste material, is fed and from which waste input points the material to be conveyed is conveyed into a conveying pipe by opening a discharge valve means, in which case, by means of the sucking effect achieved by the aid of the partial vacuum acting in the conveying pipe and also by means of the surrounding air pressure acting via the refuse chute, material such as e.g. waste material packed into bags, is conveyed from the refuse chute into the conveying pipe and onwards to a reception point, where the material to be transported is separated from the transporting air and conveyed for further processing or e.g. into a shipping container. The pneumatic waste conveying systems in question can be utilized particularly well in densely populated urban areas. These types of areas have tall buildings, in which the input of wastes into a pneumatic conveying system for wastes is performed via an input point, such as a refuse chute arranged, in the building.

Material can be conducted from an input point along a refuse chute into a container that is lower in the vertical direction, or an intermediate container can be in connection with the input points, into which intermediate container material fed from an input point is initially conducted and from where the waste material is conveyed onwards along the conveying piping to a reception point. One problem can be that the waste that has fallen at a high speed into the bottom part of the refuse chute or into the intermediate container and smashed, and which waste is tightly compacted in the bottom part, does not always displace in the desired manner into the container space of the material container from the bottom part of the refuse chute. When the waste material has become compacted onto the bottom part of the refuse chute, in the proximity of the output aperture, one problem is that the material that has compacted in the refuse chute might block the channel leading into the material container of the refuse chute, in which case conveying of the material from the refuse chute into the container space of the material container is prevented and/or the access of possible replacement air from the refuse chute into the conveying pipe is prevented. Attempts have been made to prevent compacting of the waste material by arranging mechanical obstacles in the chute, by means of which it is endeavored to slow down the falling speed of waste bags in the refuse chute. A problem with mechanical deceleration obstacles is that the waste bags often break when they hit them, in which case the wastes make the inside surface of the refuse chute unnecessarily dirty. This makes keeping the refuse chute clean more difficult and, in addition, the wastes from broken waste bags that have made the refuse chute dirty create odor nuisances. There might also be channel sections between the refuse chute and the container that hamper the conveying of material from the refuse chute into the container space. These types of channel sections can be various bends and channel sections in which the material is also conveyed in the horizontal direction.

The aim of the present invention is to achieve a new type of solution in connection with the refuse chutes of a wastes conveying system, by means of which solution the drawbacks of prior art solutions are avoided. Another aim of the invention is to achieve a solution with which the feeding in of waste material from an inlet chute into a container space is reliably facilitated.

### BRIEF DESCRIPTION OF THE INVENTION

The invention is based on a concept wherein means for circulating air are arranged in connection with the inlet chute for wastes, i.e. the refuse chute, and the container space of the material container, at least in the channel section between the end part of the refuse chute and the container space, for enhancing the displacement of waste material to be fed in the material transfer direction from the refuse chute into the container space.

The method according to the invention is mainly characterized by what is stated in claim 1.

The method according to the invention is also characterized by what is stated in claims 2-5.

The apparatus according to the invention is mainly characterized by what is stated in claim 6.

The apparatus according to the invention is also characterized by what is stated in claims 7-11.

The solution according to the invention has a number of important advantages. By means of the invention fast and effective emptying of the inlet chute, i.e. refuse chute, into a material container is achieved. With the method and the apparatus according to the invention it is possible to reduce the susceptibility to clogging of the refuse chute, in which case the operation of the wastes conveying system remains good. By means of the invention it is possible to convey material more effectively and more reliably than before from the inlet chute, i.e. the refuse chute, into the material container. The material can be conveyed effectively even if there were channel sections deviating from the vertical direction, or otherwise hampering the displacement of material, in the channel between the inlet chute and the material container or in the inlet chute. In this case the susceptibility to blockage of the channel between the inlet chute and the material container can simultaneously be reduced. By accelerating the movement speed of the waste in the inlet chute a large material container, such as a shipping container, can be filled more efficiently because the material flies farther in the container space. The solution according to the invention can be utilized in connection with various embodiments. The method and apparatus can be used together in connection with a material container, which is a shipping container. On the other hand the solution according to the invention is also suited for use in connection with the intermediate containers of extensive pneumatic waste material conveying systems. Owing to the feed device of the intermediate container, waste material is fed from the intermediate container in suitable portions, which facilitates the conveying in the conveying piping. By arranging the input aperture of the input branch coupling and the input aperture into the container space on essentially the same side and by driving the feed means in the opposite direction at least when material is conducted into the intermediate container, towards the opposite wall of the container space, the volume of the intermediate container can be utilized efficiently and at the same time the material can be compacted, i.e. made denser, in the container space.

According to the invention material input points, which are the input points of waste, such as waste receptacles or refuse chutes, can be used for feeding material. The method and apparatus according to the invention are particularly well suited in connection with conveying systems of waste material, such as waste material arranged in bags.

### BRIEF DESCRIPTION OF THE FIGURES

In the following, the invention will be described in more detail by the aid of an embodiment with reference to the attached drawings, wherein

FIG. 1 presents one simplified embodiment of an apparatus according to the invention,

FIG. 2 presents one simplified embodiment of an apparatus according to the invention, in a first operating phase, and

FIG. 3 presents one simplified embodiment of an apparatus according to the invention, in a second operating phase.

### DETAILED DESCRIPTION OF THE INVENTION

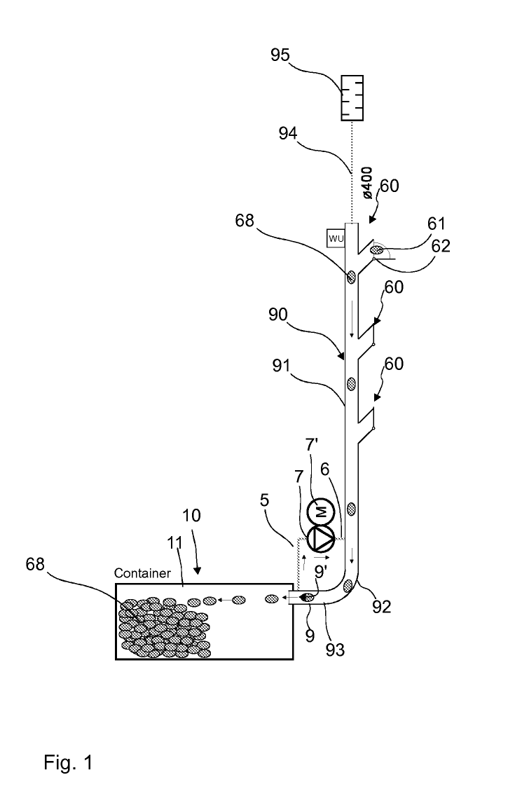

FIG. 1 presents a simplified diagram of an apparatus according to the invention. The apparatus comprises an inlet chute 90, which comprises a number of input points 60, in which are input apertures 61 for feeding in material 68 from an input aperture into the inlet chute. An openable and closable hatch 62 or corresponding is in connection with the input aperture 61 in the embodiment of the figure, which hatch when closed covers the input aperture and when open enables the feeding in of material into the inlet chute. In the figure the inlet chute is connected at the bottom part to a material container 10, which in the embodiment of the figure is presented in simplified form. The material container 10 can be e.g. a shipping container, e.g. a waste container. The inlet chute 90 comprises a mainly vertical section 91, in which in the figure input points 60 are arranged in the vertical direction at a distance from each other, e.g. on different floors. Between the vertical section 91 of the inlet chute 90 and the material container 10 is a section 92, 93 deviating from the vertical direction. In the section of the inlet chute deviating from the vertical direction is, in the embodiment of the figure, a curving section 92 and after it a mainly horizontal section 93, from where the material is conducted into the material container 10 via the input aperture 9′ in the input channel 9 of the bottom part of the inlet chute.

For enhancing the mainly gravitational infeeding of material a fan means 7, which is driven with a drive means 7′, is arranged in connection with the inlet chute and the material container.

The apparatus thus comprises fan means 7, 7′, the suction side of which fan means 7 is connected into medium connection with the container space of the material container 10, and the blowing side of which fan means 7 is connected into medium connection with the inlet chute 90 in such a way that a transporting air flow is brought about in the inlet chute in the input direction of material towards the material container at least in the section 92, 93 of the inlet chute deviating from the vertical direction. The fan means 7 is configured to be driven with a drive device 7′, e.g. with an electric motor or with another suitable drive device.

The blowing side of the fan means 7 is connected to the inlet chute 90 with the channel section 6 to a point of the inlet chute 90 that, in the conveying direction of material, is before the section 92, 93 of the inlet chute deviating from the vertical direction. Typically it is possible that when conveying material in the inlet chute just with gravity the material can agglomerate in the part of the inlet chute deviating from the vertical direction, in which case the material conveying from the inlet chute into the container space 11 of the material container 10 can be obstructed. The blowing side of the fan means 7 is connected with a channel section 6 to a point of the inlet chute 90, which in the conveying direction of material is before the point causing a possible agglomeration of material, such as before the channel section 92, 93 deviating from the vertical direction. In the embodiment of the figures, the blowing side of the fan means 7 is connected to the bottom part of the inlet chute 90 with the channel section 6.

In the embodiment of the figures the suction side of the fan means 7 is arranged with the suction channel section 5 into medium connection with the material space 11 of the material container 10. In FIG. 1 the suction side is arranged with the suction channel section into the bottom part of the inlet chute 90, e.g. in the input channel 9, which is in medium connection with the container space of the material container. According to a second embodiment the suction channel is connected directly to the top part of the container space of the material container. In this case the suction channel part 5 is arranged e.g. in the top part of the material container 10 at the end on the input channel 9 side. In this case the suction channel 5 is arranged in the top wall of the material container 10, but it can be arranged also elsewhere, e.g., in a side wall.

According to one embodiment a transporting air flow having a flow speed of approx. 2-10 m/s is configured to be brought about with the arrangement of the invention in the inlet chute 90, e.g. in the bottom part of it. The flow rate can depend on the application site and it can be smaller or greater than the values presented.

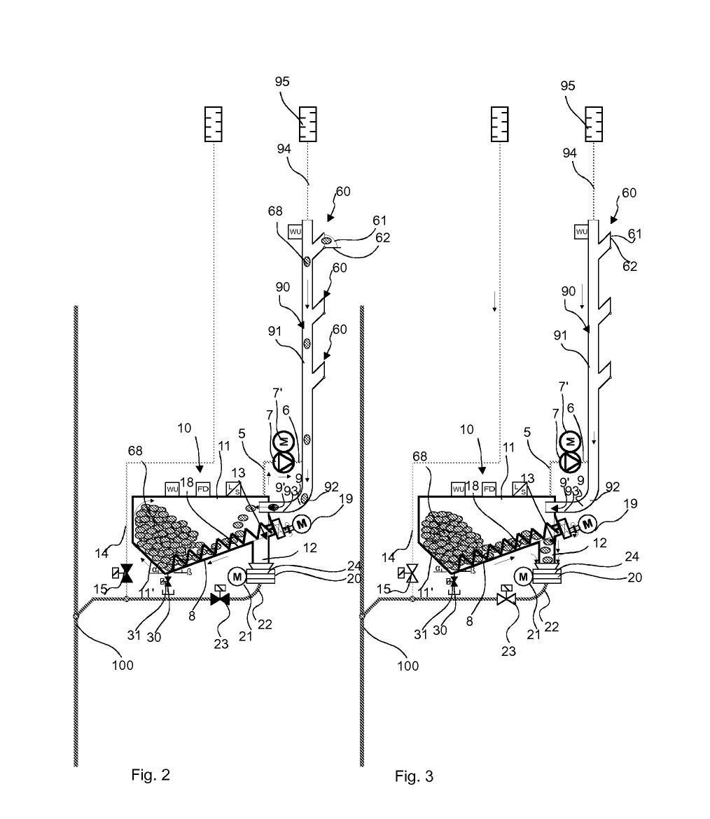

FIGS. 2 and 3 present a simplified diagram of an apparatus according to one embodiment of the invention, arranged in connection with an input point for material, or in the proximity of it, said apparatus being for feeding waste material into the conveying piping 100 of a pneumatic waste material conveying system. The apparatus comprises at least one input point 60, an inlet chute 90 and an intermediate container 10 that is a material container, into which waste material is arranged to be conveyed from an input point 60 via an inlet chute 90, and also means for conveying waste material from an input point into the intermediate container 10, from where the waste material is conveyed onwards in the conveying piping 100 of the pneumatic conveying system for waste material. In the conveying piping 100 the waste material displaces together with the transporting air to a reception point, such as a waste station, of the system, in which separating means the waste material to be transported is separated from the transporting air and conveyed for further processing or into a shipping container. The operation of a pneumatic wastes conveying system is not described in more detail here. Various examples of pneumatic wastes transporting systems are presented generally, e.g. in publications WO 2009/080880, WO 2009/080881, WO 2009/080882, WO 2009/080883, WO 2009/080884, WO 2009/080885, WO 2009/080886, WO 2009/080887, WO 2009/080888, and WO/2011/110740.

The intermediate container 10 functioning as a material container comprises a container space 11 and a feed container part 12, and also a input aperture 13 between the container space and the feed container part, as well as feed means 18, 19 for conveying waste material from the container space 11 via the input aperture 13 into the feed container part 12 of the intermediate container. The base wall 8 of the container space 11 is arranged to slope at least partly upwards with respect to the horizontal direction at an angle β and/or the feed means 18 is arranged to be inclined in the conveying direction upwards with respect to the horizontal direction at an angle 3, towards the input aperture 13. The feed means 18, in the embodiment of the figures, is a feed screw, which is driven with a drive means 19, e.g. with an electric motor.

Material is fed into an input point 60, e.g. into a refuse chute, via one or more input apertures. A hatch arrangement 62 or similar can be in connection with the input aperture 62. Additionally, a valve means can be in connection with an input aperture, with which valve means access of material into the feed container, such as into a container of the refuse chute, is adjusted. Typically waste material is dropped from the input aperture into the refuse chute 90. A number of input apertures 61, typically at least one for each floor of the building, are arranged in the refuse chute.

The inlet chute, i.e. refuse chute, is connected from its bottom part to the container space 11 of the intermediate container 10 via an input channel 9, as in FIGS. 2 and 3.

In the top part of the inlet chute 90 is an inlet air channel 94 and a noise damper 95 connected to it.

In the embodiment of FIG. 2 with the arrangement of the invention, wherein the suction side of the fan means 7 is connected with a suction channel 5 to the material space of the intermediate container 10 functioning as a material container, and the blowing side with a channel 6 to the inlet chute 90, effective displacement of material is achieved from the inlet chute into the intermediate container 10 functioning as a material container.

The material is fed from an input point from the effect of either the suction brought about by a partial-vacuum generator of the pneumatic waste conveying system and/or from the effect of gravity into the container space 11 of the intermediate container, in which case it tries to pack into the bottom part of the container space 11. In a conventional arrangement there is a risk of clogging of the output aperture of the intermediate container and in pneumatic systems a risk of prevention of the access of replacement air that is essential from the viewpoint of operation in the discharge phase of the container.

For avoiding the drawbacks of prior art, the intermediate container 10 is divided into a container space 11 and a feed container part 12, and is also provided with a sloping base 8 and/or with feed means 18, such as a feed screw, inclined upwards, which is driven with a drive device 19. The material that has accumulated in the container space of the intermediate container is conveyed with the feed means 18 towards the input aperture 13. The waste drops into the feed container part 12, from where it is conveyed onwards.

The feed means 18 is configured to be driven according to need or periodically, in which case a suitable batch of waste material to be conveyed can be conveyed from the container space 11 into the feed container part 12 of the intermediate container.

The upward sloping feed means 18 and/or base part 8 enable the waste material packed onto the base part of the container to be conveyed in suitable batches into the feed container part without any fear of the output aperture of the intermediate container clogging. In this case the material can be conveyed in suitable batches into the conveying piping 100 when the intermediate container is emptied.

In the embodiments of FIGS. 2 and 3, a rotary shaper 20 (formatter) of the material is arranged in connection with the intermediate container 10, which rotary shaper shapes/compresses the material into a size of smaller diameter to fit into the outlet pipe 22 via the output aperture 24 and onwards into the conveying pipe 100. When the valve means 23 of the outlet pipe 22 is opened, the material displaces from the feed container part 12 of the intermediate container via the feed pipe 22 into the conveying piping 100.

Rotary shapers and the operation of them are presented in more detail in publications WO/2011/098666, WO/2011/098667, WO/2011/098668 and WO/2011/098669.

FIGS. 2 and 3 thus present an embodiment of the invention in connection with an intermediate container functioning as a material container 10. In the embodiment the shape of the intermediate container 10 and the placement of the input branch coupling 9 of the inlet chute 90 and the placement of the input aperture 13 as well as the placement point of the feed container 12 are arranged in essentially the same part of the container space 11 of the material container 10. In the embodiment the feed container part 12 is arranged downwards from the input aperture 13 formed in the base 8 of the container space. The input aperture 9′ into the container space 11 of the input branch coupling 9 is arranged in the container space in the same end part in which the input aperture 13 is situated, upwards from the input aperture.

The input branch coupling 9 connected to the material container 10 of the inlet chute 90 is, according to one embodiment, arranged to direct the material being conducted into the container space to some extent in the horizontal direction. In this case the material is conducted into the container space from the input aperture 9′ of the input branch coupling towards the opposite wall 11′ of the container space 11. For conducting the material farther from the input aperture 9′ in the container space and for compacting the material in the container space, the feed means 18 of the container space is configured to convey the material, in the embodiment of the figure, away from the input aperture 9′ of the input branch coupling 9 and/or from the input aperture 13. The waste material does not displace horizontally very far in the container space from the input branch coupling 9, in which case the feed means 18, which can be e.g. a feed screw, conveys waste material in the container space backwards/into the rear part, preferably towards the opposite wall 11′ of the container space. The feed movement brought about by the feed means 18 on the waste material thus also causes the waste material to displace in the container space 11 towards its rear wall 11′, in which case the rear wall 11′ of the container space, which rear wall 11′ is formed to be initially inclined upwards from its bottom part from the base part 8 of the container part (at an angle of a (alfa) with respect to the horizontal) and then to be vertical, turns the material in the input container. FIG. 2 describes the conveying of material via its rear wall 11′ upwards and it fills the container space 11 efficiently. At the same time the waste material is compacted with the feed means 18, in which case more of it can be made to fit into the container space than without compacting.

According to one embodiment with an arrangement according to the invention up to twice as much waste can be fitted into the container space as without compacting.

FIG. 2 presents a situation in which waste material 68 is conveyed from an input point 60, which is arranged in connection with a refuse chute, via the input branch coupling 9 and the input aperture 9′ into the container space 11 of the intermediate container 10. In the embodiment of FIG. 2 the suction side of the fan means 7 is connected into medium connection with the container space of the material container 10, and the blowing side of which fan means 7 is connected into medium connection with the inlet chute 90 in such a way that a transporting air flow is brought about in the inlet chute in the conveying direction of material towards the material container at least in the section 92, 93 of the inlet chute 90 deviating from the vertical direction.

The material displaces into the container some distance from the input aperture 9′ towards the opposite wall 11′ of the container 10. The feed screw functioning as a feed means 18 is driven in this operating phase such that the feed means conducts material away from the input aperture 9′ and/or from the input aperture 13, towards the rear wall 11′ of the container space, filling the container space 11 of the intermediate container and at the same time compacting the material, i.e. making it denser, in the container space of the container space.

When it is desired to convey the waste material from the intermediate container 10, out of its container space 11, the feed means 18 is driven in such a way that that it conveys the waste material towards the input aperture 13 between the container space 11 and the feed container part 12, from where the waste material is conducted into the feed container part 12. In the embodiment of FIG. 3 the feed means is a feed screw, the direction of rotation of which has been changed to the operating phase of FIG. 3, to be opposite to the operating phase of FIG. 2. In the operating phase of FIG. 3 the movement of the material towards the input aperture 13 and onwards into the feed container part 12 is described with an arrow. In the operating phase of FIG. 3 air is not blown into the inlet chute with the blowing means 7.

The waste material conducted into the feed container part 12 is conducted onwards and processed with a rotary shaper 20 arranged in the bottom part of the feed container part, into the input aperture of which rotary shaper the material is conducted from the feed container part 12, said input aperture being simultaneously the output aperture 24 of the feed container part 12.

In the embodiment of FIGS. 2-3 the feed container part 12 is the feed duct of the rotary shaper 20, from which feed duct the waste material is conducted into the input aperture of the rotary shaper 20, and after processing onwards into the conveying pipe 100.

When the valve means 23 of the outlet pipe 22 is opened, the material displaces from the feed container part 12 of the intermediate container via the output aperture 24 and the feed pipe 22 into the conveying piping 100, in which partial vacuum acts at least at the moment of emptying the feed container part 12.

FIGS. 2 and 3 present one embodiment wherein a valve means 15, with which the connection can be opened and closed, is arranged in the replacement air duct 14 of the conveying pipe 100.

According to one embodiment, a fluid removal branch coupling 30 is arranged in the intermediate container 10, in its container space 11, in the bottom part of it, for removing fluid that has collected in the container space. The fluid removal branch coupling 30 is preferably disposed at the lowest point of the container or in the proximity of it. In the embodiment of the figure the fluid removal branch coupling is at the point of connection of the base part 8 of the container space and the wall 11′. A valve means 31 is arranged in the fluid removal branch coupling 30 in FIGS. 2 and 3.

The invention thus relates to a method for feeding in waste material from an inlet chute 90 into the container space of a material container 10, in which inlet chute 90 is arranged at least one input point 60, in which is an input aperture 61 for feeding in material 68 into the inlet chute and onwards along a channel section of the inlet chute into a material container 10, which inlet chute comprises a mainly vertical channel section 91 and a section 92, 93 deviating from the vertical direction. The conveying of material to be conveyed in the inlet chute 90 is enhanced at least in the section 92, 93 of the inlet chute deviating from the vertical direction by bringing about a transporting air flow in the inlet chute in the input direction of material towards the material container 10, which transporting air flow is brought about at least partly with a fan means 7, the blowing side of which fan means is connected into medium connection with the inlet chute 90 and/or the suction side of the fan means is connected into medium connection with the container space of the material container 10.

According to one embodiment the material is conveyed at least a part of the distance in the inlet chute 90 mainly by the aid of gravity.

According to one embodiment material is fed from the inlet chute 90 into a material container 10, which is a shipping container.

According to one embodiment material is fed from the inlet chute 90 into a material container 10, which is an intermediate container, from where the material is conveyed onwards, e.g. along a conveying pipe 100 of a pneumatic material conveying system.

According to one embodiment a transporting air flow having a speed of approx. 2-10 m/s is brought about in the bottom part of the inlet chute 90.

The invention also relates to an apparatus for feeding in waste material from an inlet chute 90 into the container space of a material container 10, in which inlet chute 90 is arranged at least one input point 60, in which is an input aperture 61 for feeding in material 68 into the inlet chute and onwards along a channel section of the inlet chute into a material container 10, which inlet chute 90 comprises a mainly vertical channel section 91 and a section 92, 93 deviating from the vertical direction. The apparatus comprises fan means 7, 7′, the suction side of which fan means 7 is connected into medium connection with the container space of the material container 10, and the blowing side of which fan means 7 is connected into medium connection with the inlet chute 90 in such a way that a transporting air flow is brought about in the inlet chute in the conveying direction of material towards the material container at least in the section 92, 93 of the inlet chute deviating from the vertical direction.

According to one embodiment the blowing side of the fan means 7 is connected to the inlet chute with a channel section 6 to a point of the inlet chute that, in the conveying direction of material, is before the section 92, 93 of the inlet chute deviating from the vertical direction.

According to one embodiment the suction side of the fan means 7 is arranged with a suction channel section 5 into the top part of the material space of the material container 10.

According to one embodiment the blowing side of the fan means 7 is arranged with a suction channel section 5 into the bottom part of the inlet chute 90, most suitably in the proximity of the material container.

According to one embodiment the blowing side of the fan means 7 is connected with a channel section 6 into the bottom part of the inlet chute 90.

According to one embodiment the suction side of the fan means 7 is arranged with a suction channel section into the inlet chute closer to the material container in the direction of travel of the material than the blowing side of the fan means with the channel section 6.

According to one embodiment a transporting air flow having a speed of approx. 2-10 m/s is arranged to be brought about in the bottom part of the inlet chute.

Typically the material is waste material, such as waste material arranged in bags. An input point and an intermediate container can be configured to be a part of a pneumatic waste conveying system or it can be a separate part, in which waste material is conducted into a waste room, waste container or corresponding.

It is obvious to the person skilled in the art that the invention is not limited to the embodiments presented above, but that it can be varied within the scope of the claims presented below. The characteristic features possibly presented in the description in conjunction with other characteristic features can if necessary be used separately to each other.

1. Method for feeding in waste material from an inlet chute into the container space of a material container, in which inlet chute is arranged at least one input point, in which is an input aperture for feeding in material into the inlet chute and onwards along a channel section of the inlet chute into a material container, which inlet chute comprises a mainly vertical channel section and a section deviating from the vertical direction,
wherein the conveying of material to be conveyed in the inlet chute is enhanced at least in the section of the inlet chute deviating from the vertical direction by bringing about a transporting air flow in the inlet chute in the input direction of material towards the material container, which transporting air flow is brought about at least partly with a fan means, the blowing side of which fan means is connected into medium connection with the inlet chute and/or the suction side of the fan means is connected into medium connection with the container space of the material container.

2. Method according to claim 1, wherein the material is conveyed at least a part of the distance in the inlet chute mainly by the aid of gravity.

3. Method according to claim 1, wherein material is fed from the inlet chute into a material container, which is a shipping container.

4. Method according to claim 1, wherein the material is fed from the inlet chute into a material container, which is an intermediate container, from where the material is conveyed onwards, e.g. along a conveying pipe of a pneumatic material conveying system.

5. Method according to claim 1, wherein a transporting air flow having a speed of approx. 2-10 m/s is brought about in the bottom part of the inlet chute.

6. Apparatus for feeding in waste material from an inlet chute into the container space of a material container, in which inlet chute is arranged at least one input point, in which is an input aperture for feeding in material into the inlet chute and onwards along a channel section of the inlet chute into a material container, which inlet chute comprises a mainly vertical channel section and a section deviating from the vertical direction,
wherein the apparatus comprises fan means, the suction side of which fan means is connected into medium connection with the container space of the material container, and the blowing side of which fan means is connected into medium connection with the inlet chute in such a way that a transporting air flow is brought about in the inlet chute in the conveying direction of material towards the material container at least in the section of the inlet chute deviating from the vertical direction.

7. Apparatus according to claim 6, wherein the blowing side of the fan means is connected to the inlet chute with a channel section to a point of the inlet chute that, in the conveying direction of material, is before the section of the inlet chute deviating from the vertical direction.

8. Apparatus according to claim 6, wherein the suction side of the fan means is arranged with a suction channel section into the top part of the material space of the material container.

9. Apparatus according to claim 6, wherein the blowing side of the fan means is arranged with a suction channel section into the bottom part of the inlet chute, most suitably in the proximity of the material container.

10. Apparatus according to claim 6, wherein the blowing side of the fan means is connected with a channel section into the bottom part of the inlet chute.

11. Apparatus according to claim 6, wherein a transporting air flow having a speed of approx. 2-10 m/s is arranged to be brought about in the bottom part of the inlet chute.

12. Method according to claim 2, wherein material is fed from the inlet chute into a material container, which is a shipping container.

13. Method according to claim 2, wherein the material is fed from the inlet chute into a material container, which is an intermediate container, from where the material is conveyed onwards, e.g. along a conveying pipe of a pneumatic material conveying system.

14. Method according to claim 2, wherein a transporting air flow having a speed of approx. 2-10 m/s is brought about in the bottom part of the inlet chute.

15. Method according to claim 3, wherein a transporting air flow having a speed of approx. 2-10 m/s is brought about in the bottom part of the inlet chute.

16. Method according to claim 4, wherein a transporting air flow having a speed of approx. 2-10 m/s is brought about in the bottom part of the inlet chute.

17. Apparatus according to claim 7, wherein the suction side of the fan means is arranged with a suction channel section into the top part of the material space of the material container.

18. Apparatus according to claim 7, wherein the blowing side of the fan means is arranged with a suction channel section into the bottom part of the inlet chute, most suitably in the proximity of the material container.

19. Apparatus according to claim 7, wherein the blowing side of the fan means is connected with a channel section into the bottom part of the inlet chute.

20. Apparatus according to claim 8, wherein the blowing side of the fan means is connected with a channel section into the bottom part of the inlet chute.
